(19) United States
(12) Patent Application Publication
(10) Pub. No.: US 2018/0051220 A1
(43) Pub. Date: Feb. 22, 2018

(54) SMALL INTERNAL COMBUSTION ENGINE FUELS

(71) Applicant: Swift Fuels, LLC, West Lafayette, IN (US)

(72) Inventors: Chris D'Acosta, West Lafayette, IN (US); Thomas Albuzat, Homburg (DE)

(73) Assignee: Swift Fuels, LLC, West Lafayette, IN (US)

(21) Appl. No.: 15/800,181

(22) Filed: Nov. 1, 2017

Related U.S. Application Data
(63) Continuation of application No. 14/701,934, filed on May 1, 2015.
(60) Provisional application No. 61/986,931, filed on May 1, 2014.

(51) Int. Cl. C10L 1/06; C10L 10/00; C10L 10/02; C10L 10/04; F02B 43/04; F02B 75/02; C10L 1/00

(52) U.S. Cl. CPC C10L 1/06; C10L 10/00; C10L 10/02; C10L 10/04; F02B 43/04; F02B 75/02; C10L 2270/023; C10L 2230/10; C10L 2230/18; F02B 2075/025; F02B 2075/027; Y02T 10/32; C10L 1/003

(57) ABSTRACT

Disclosed herein are motor fuels providing enhanced properties for use with 2-stroke and 4-stroke engines. The fuels comprise isooctane, alkylate, mesitylene, isopentane and butane, and optionally a special lube oil premixed in solution.

### BACKGROUND

Spark-ignited internal combustion engines come in a wide variety of shapes and sizes and are widely used for automotive engines (as distinguished from jet-fuel turbine engines or diesel engines). There is a growing market of smaller combustion engines, notable 2-stroke (or 2-cycle) and 4-stroke (4-cycle) engines that are used in variety of portable machines including chain saws, lawnmowers, edgers, pumps, dirt bikes, outboard motors, motorcycles, mopeds, snowmobiles, gas-powered fans, generators, handheld blowers, motor scooters, 4-wheelers, radio-controlled models, ultra-light airplanes and piston-powered unmanned aviation vehicles.

The 2-stroke variety of engines is generally considered to require lubricating oil in the combustion chamber, but often smokes (so called blue smoke) and emits other forms of pollution which can irritate the user of a handheld application such as a chainsaw, and generally be a nuisance. The 4-stoke variety are generally larger engines which do not require a lubricant, but nevertheless may emit various pollutants depending upon the choice of fuel.

The availability of gasoline to power 2-stroke and 4-stroke engines has evolved over the years. Auto gasoline is now largely tailored to include ethanol, a water soluble fuel, which is generally not desirable for 2- or 4-stroke engines as it can rust the fuel system, damage parts or cause rough-idle knocking. Auto gasoline also has vapor pressure requirements which may not be helpful for cold weather application such as snowmobiles or hot desert conditions. So some retailers are providing a simplified auto gasoline without ethanol, but many consumers are now realizing their engines still become fouled by these fuels. In addition, these smaller machines are often used only periodically or seasonally and may sit for long periods in either hot or cold weather, resulting in the fuel changing its composition and then once used again, reducing its effectiveness—or harming the engine. As yet another alternative, some consumers try to use 100LL aviation gasoline (a higher octane product for piston engines, with low vapor pressure) not realizing the human toxicity dangers of lead when used in close proximity to their machine. To these situations, some consumers may add standard lubricating oils to the gasoline mix, only to find gumming of the engine, fouling of the spark plugs and overall unsatisfactory results. Certain lubricating oils do not mix in-solution and may fail to perform in these engine application.

### SUMMARY

The invention is a highly selective formulation of gasoline components to maximize the start-up capability (low vapor pressure) in cold and hot weather, and provide clean-running performance of the engine (using purified components often not found in auto gasoline) to increase the power, safety, stability and shelf life of the fuel.

### EXAMPLE 1 (4-STROKE)

| | |
|---|---|
| Isooctane | 58% |
| Alkylate | 25% |
| Isopentane | 15% |
| Butane | 2% |
| Total | 100% |

### EXAMPLE 2 (2-STROKE)

| | |
|---|---|
| Isooctane | 56% |
| Alkylate | 25% |
| Isopentane | 15% |
| Butane | 2% |
| Lub Oil | 2% (50:1) |
| Total | 100% |

### EXAMPLE 3 (4-STROKE)

| | |
|---|---|
| Isooctane | 57% |
| Alkylate | 18% |
| Isopentane | 15% |
| Mesitylene | 10% |
| Total | 100% |

### EXAMPLE 4 (2-STROKE)

| | |
|---|---|
| Isooctane | 57% |
| Alkylate | 16% |
| Isopentane | 13% |
| Mesitylene | 10% |
| Lub Oil | 2% (50:1) |
| Butane | 2% |
| Total | 100% |

Experiments were then performed comparing conventional (store-bought) versions of these 4-stroke and 2-stroke fuels including:

| 4-Stroke | 2-Stroke |
|---|---|
| Trufuel 4-stroke | Trufuel 2-stroke (50:1) |
| 93 Autogas (w/o ethanol) | Husqvarna 2-stroke (50:1) |
| VP Racing 4-stroke | Echo Power 2-stroke (50:1) |
| 100LL avgas | VP Racing 2-stroke (50:1) |

The testing showed our fuel had no gumming, no deposits on the spark plugs, no toxic chemicals, no aromatics and no visible smoke, with rapid starting (within first 2 vs. up to 11 times for others), 60-90% less carbon monoxide emissions, smooth idling and no harsh smells. Each of the competitive products had signs of deposits, visible smoke, slow/unreliable starts and strong smells. The 100LL contains tetraethyl lead. The auto gas and avgas both contained aromatics up to 25%. Many of the fuels contained unspecified middle distillates—but not pure fuel components.

Consumers found our fuel to be highly cost effective by lowering the cost of additives and special treatments (attempting to overcome fouling and gumming), and the elimination of unnecessary engine repair bills and lower overall equipment maintenance costs. Emergency workers also stated the reliability of the engine starting of this formulation was a clear and remarkable difference. Outdoor users also appreciated our use of a fragrance and dye for special applications.

Additional engine results were obtained for the ultralight and UAV aircraft engines which showed . . . .

We believe this unique set of formulations is widely beneficial to all 2-stroke and 4-stroke engine users including fire departments, municipal governments, military and civil UAV flyers, ultralight hobbyists, outboard motorists, lawn and garden firms, winter sports shops, summer recreation shops, commercial businesses, motor cyclists, property owners and residential homeowners.

1) 4-stroke fuel comprising Isooctane (40-65%), Alkylate (15-30%), Mesitylene (0-15%), Isopentane (10-20%) and Butane (0-5%).

2) A 2-stroke fuel taking the compositions in claim 1 plus up to 2% w/w % special lub oil premixed in solution.

3) claims 1 and 2 with a fragrance enhancing additive and/or a color dye.
